(19) United States
(12) Patent Application Publication
(10) Pub. No.: US 2013/0135633 A1
(43) Pub. Date: May 30, 2013

(54) IMAGE PROCESSING APPARATUS, CONTROLLING METHOD OF IMAGE PROCESSING APPARATUS, AND STORAGE MEDIUM

(71) Applicant: CANON KABUSHIKI KAISHA, Tokyo (JP)

(72) Inventor: Hirokazu Tamura, Kawasaki-shi (JP)

(73) Assignee: CANON KABUSHIKI KAISHA, Tokyo (JP)

(21) Appl. No.: 13/675,347

(22) Filed: Nov. 13, 2012

(30) Foreign Application Priority Data
Nov. 30, 2011 (JP) 2011-262271

(51) Int. Cl. H04N 1/60

(52) U.S. Cl. CPC H04N 1/60
USPC 358/1.9

(57) ABSTRACT

The present invention aims to eliminate a ground color of an original from image data generated by a reading unit. To achieve this, a user sets elimination levels of a plurality of color components for each of the plurality of color components while confirming the image data. Then, a process of eliminating the ground color of the original from the image data is performed based on a setting by the user.

### BACKGROUND OF THE INVENTION

1. Field of the Invention

The present invention relates to an image processing apparatus, a controlling method of the image processing apparatus, and a storage medium for storing a program to perform the controlling method.

2. Description of the Related Art

Conventionally, in an image reading apparatus which is typified by a scanner, a facsimile, a copying machine or the like, a ground color eliminating process of eliminating a ground color (or a paper color) of an original is performed when an image is read from the original and the read image is then formed on a paper or the like. Under normal conditions, the paper itself of the read original has a color of a certain level of density. For this reason, if copying for the read original is performed as it is, the ground color of the paper is reproduced together with image colors, and the reproduced ground color expands entirely to the reproduction. Consequently, it is necessary by the above ground color eliminating process to eliminate the color expanding entirely to the reproduction.

As to the ground color eliminating process, it has been known a method of once capturing an image by scanning it, creating a histogram by scanning the captured image, specifying the density of the ground color based on the created histogram, and then eliminating the specified density.

In the conventional scanner, the conventional facsimile and the conventional copying machine using the above method, a series of operations of specifying the ground color, eliminating the specified ground color and forming the image is automatically performed. For this reason, if the ground color is erroneously specified, a high-density color is judged as the ground color more than necessary, and the necessary color is involuntarily eliminated. Thus, it is conceivable that the color of the primary original portion is made thin, and it is also conceivable that the ground color is not sufficiently eliminated to the contrary. In such cases, for example, Japanese Patent Application Laid-Open No. 2006-270650 discloses a method of preventing such insufficient and excessive eliminations of the ground color by simulating a result of adjustment of the elimination and displaying the obtained result to a user.

However, the method disclosed in Japanese Patent Application Laid-Open No. 2006-270650 has the following problems.

That is, in a case where a paper of which the ground color includes a color component is used, when the ground color is specified for each color component, it is necessary to specify the ground color while considering an entire balance of respective colors. Therefore, if the balance is lost, the ground color is not completely eliminated, and also a hue of the image itself is changed. Moreover, in a case where the ground color is adjusted in regard to each of the plurality of color components, it is difficult for the user to discriminate what kind of adjustment value the ground color to be eliminated is actually eliminated based on.

The present invention has been completed to solve the above problems, and an object thereof is to provide a mechanism by which, to eliminate the ground color of an original from image data generated by a reading unit, a user independently sets an elimination level for each of a plurality of color components while confirming the image data.

### SUMMARY OF THE INVENTION

To achieve the above object, there is provided an image processing apparatus which is characterized by comprising: a reading unit configured to generate image data by reading an original; a displaying unit configured to display a setting section on which it is possible to set an elimination quantity for eliminating a ground color of the original from the image data to each of a plurality of color components and the image data, on an identical screen; and an image processing unit configured to eliminate the ground color of the original from the image data based on the elimination quantity set on the setting section, wherein the displaying unit again displays the image data from which the ground color of the original has been eliminated by the image processing unit.

Further features of the present invention will become apparent from the following description of exemplary embodiments with reference to the attached drawings.

### BRIEF DESCRIPTION OF THE DRAWINGS

FIG. 1 is a block diagram for describing a constitution of an image processing apparatus.

FIG. 2 is a cross-section diagram of the image processing apparatus illustrated in FIG. 1.

FIG. 3 is a flow chart for describing a controlling method of the image processing apparatus.

FIG. 4 is a characteristic diagram illustrating RGB distributions of an original image to be read by the image processing apparatus.

FIGS. 5A, 5B, 5C and 5D are diagrams for describing states of a ground color eliminating process to be performed by the image processing apparatus.

FIG. 6 is a diagram illustrating an example of a user interface of the image processing apparatus.

FIG. 7 is a flow chart for describing a controlling method of the image processing apparatus.

FIG. 8 is a diagram illustrating an example of the user interface of the image processing apparatus.

FIG. 9 is a flow chart for describing a controlling method of the image processing apparatus.

FIG. 10 is a diagram illustrating an example of the user interface of the image processing apparatus.

### DESCRIPTION OF THE EMBODIMENTS

Preferred embodiments of the present invention will now be described in detail with reference to the attached drawings.

### Description of System Configuration

### First Embodiment

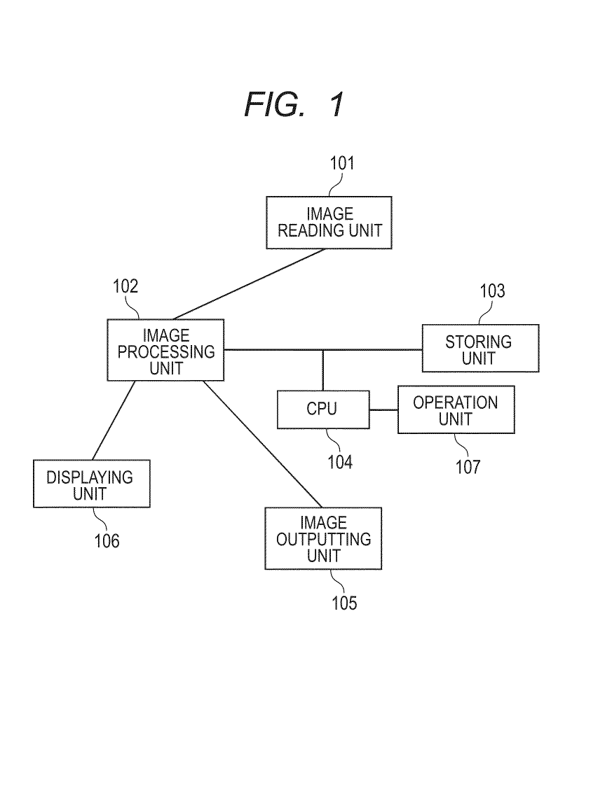

FIG. 1 is a block diagram for describing a constitution of an image processing apparatus indicating the present embodiment. The image processing apparatus indicated in the present embodiment can be connected to a server which manages image data, a personal computer (PC) which instructs to perform the printing and the like through a network or the like.

In FIG. 1, an image reading unit 101 reads an image of an original and outputs image data. An image processing unit 102 converts print information including image data, which is input from the image reading unit 101 or an external unit, into intermediate information (hereinafter referred to as “object”) and then stores the object in an object buffer of a storing unit 103. In that case, an image processing such as color correction or the like is performed. Further, bit map data is generated on the basis of the buffered object and the generated bit map data is stored in a buffer of the storing unit 103. In that case, the image processing unit 102 analyzes the above bit map data and then performs a ground color judging process, a ground color eliminating process, a density correcting process, a color converting process and the like every color. Details about these processes will be described later.

The storing unit 103 is composed of a ROM, a RAM, a hard disk (HD) and the like. Here, the ROM stores various control programs or an image processing program executed by a CPU 104. The RAM is used as a reference area or a work area, where the CPU 104 stores data or various information. The RAM and the HD are used for the above object buffer.

Image data are accumulated on the RAM and the HD, and a program for sorting pages and data of the originals having plural sorted pages are accumulated to perform a printout of plural copies.

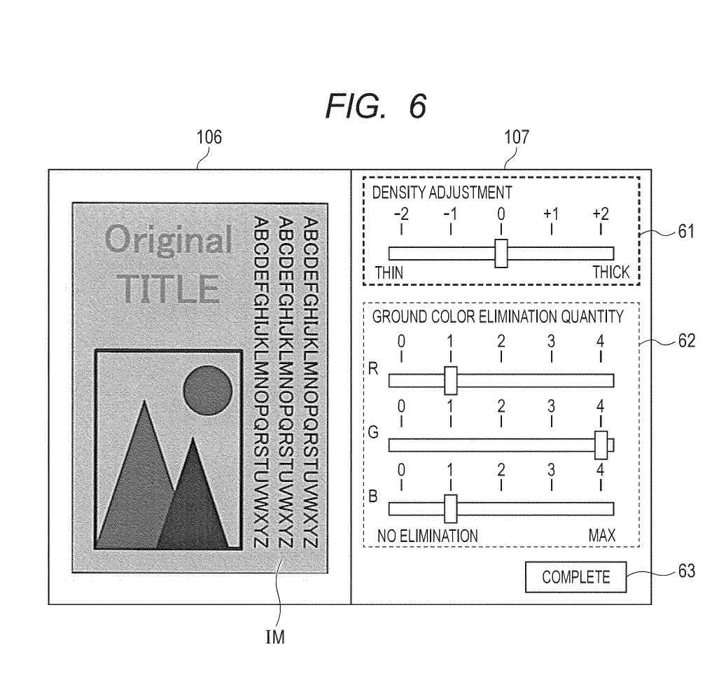

An image outputting unit 105 forms a color image and outputs the color image on a recording medium such as a recording paper. A displaying unit 106 displays a result of a process performed in the image processing unit 102 and confirms a result by previewing an image after performing an image processing. An operation unit 107, which accepts settings set from a user, accepts operations of various settings such as the setting of the number of copies to be copied or a double-sided copy, the original setting whether a color copying process is performed or a monochrome copying process is performed and the setting related to a ground color adjusting request or a density adjusting request. Incidentally, it is possible to constitute an integrated unit, for example, by using a touch panel so that the displaying unit 106 is integrated with the operation unit 107, and an example thereof will be described in FIG. 6.

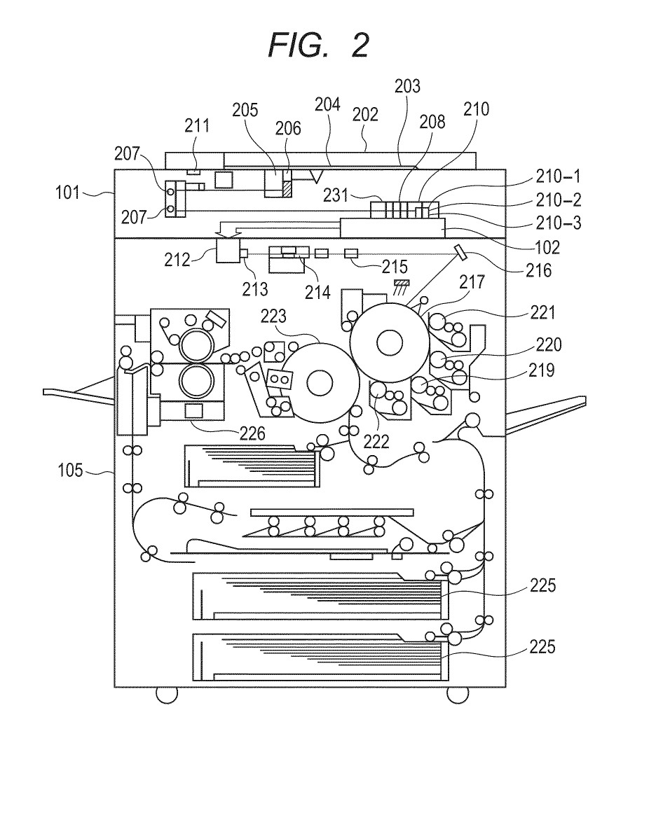

FIG. 2 is a cross-section diagram of the image processing apparatus illustrated in FIG. 1.

In FIG. 2, an original 204 is laid between an original glass plate 203 and an original pressing plate 202 on the image reading unit 101, and the original 204 is irradiated by the light from a lamp 205. The reflected light emitted from the original 204 is guided to mirrors 206 and 207 to be focused into an image on a 3-line sensor 210 by a lens 208. Incidentally, an infrared cut filter 231 is provided at the lens 208. A mirror unit which includes the mirror 206 and the lamp 205 is moved at a speed of V and a mirror unit which includes the mirror 207 is moved at a speed of V/2 to the direction parallel with the original glass plate 203 by a motor which is not illustrated. That is, the mirror units move to the vertical direction (sub-scanning direction) to the electrical scanning direction (main scanning direction) of the 3-line sensor 210 and scan a whole surface of the original 204.

The 3-line sensor 210 composed of three line CCDs (Charge Coupled Devices) performs the color separation to optical information to be input and reads respective color components of full-color information of red (R), green (G) and blue (B) and then transmits color component signals thereof to the image processing unit 102.

Incidentally, the CCDs, which compose the 3-line sensor 210, respectively have light receiving elements corresponding to 5000 pixels and can read an A3 sized original equal to the maximum sized original, which can be mounted on the original glass plate 203, to the short direction (297 mm) with the resolution of 600 dpi.

A standard white plate 211 is used for performing correction (for example, shading correction) to data which was read by respective CCDs 210-1 to 210-3 of the 3-line sensor 210. A color of the standard white plate 211 is white, which indicates almost the uniform reflection characteristic with a visible light.

The image processing unit 102 electrically processes image signals to be input from the 3-line sensor 210 and generates respective color component signals of cyan (C), magenta (M), yellow (Y) and black (B) and then transmits the generated color component signals of C, M, Y and K to the image outputting unit 105. An image to be output at this time has become an image of C, M, Y and K to which a halftone process, such as a dither process, has been performed.

In the image outputting unit 105, an image signal of C, M, Y or K transmitted from the image reading unit 101 is transmitted to a laser driver 212. The laser driver 212 performs a modulation drive to a semiconductor laser device 213 in accordance with the image signal to be input. A laser beam, which is output from the semiconductor laser device 213, scans a photosensitive drum 217 through a polygon mirror 214, an f-θ lens 215 and a mirror 216 and forms an electrostatic latent image on the photosensitive drum 217.

A developing unit is composed of a magenta developing unit 219, a cyan developing unit 220, a yellow developing unit 221 and a black developing unit 222. The electrostatic latent image formed on the photosensitive drum 217 is developed by toners of corresponding colors by operating that the four developing units mutually contact with the photosensitive drum 217 and then a toner image is formed. A recording paper supplied from a recording paper cassette 225 is coiled around a transfer drum 223, and the toner image on the photosensitive drum 217 is transferred to the recording paper.

Then, the recording paper, to which toner images of four colors of C, M, Y and K are sequentially transferred in this manner, is discharged to the outside of the apparatus after the toner image was fixed by passing through a fixing unit 226.

Hereinafter, an eliminating process of original ground color and an adjusting process of the eliminating quantity of original ground color in the image processing apparatus indicating the present embodiment will be described in detail.

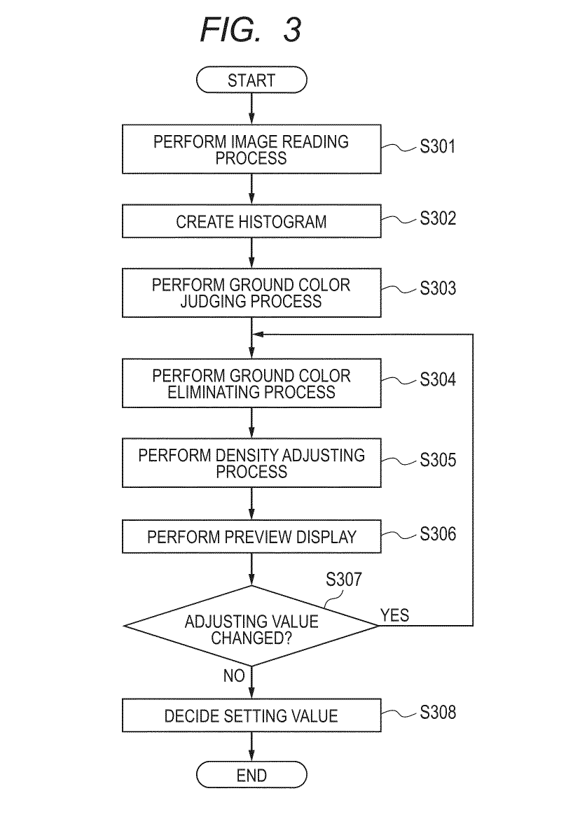

FIG. 3 is a flow chart for describing a controlling method of the image processing apparatus indicating the present embodiment. The present example corresponds to a processing example, wherein when the image reading unit 101 illustrated in FIG. 1 performed to read an original, the eliminating quantity of ground color is automatically discriminated from image data which was read and the ground color is eliminated in accordance with a value of the automatically discriminated eliminating quantity and then the density is adjusted to display the adjusted result. Reference symbols S301 to S308 denote respective steps, and a procedure in each of these steps is realized by a process that the CPU 104 executes a control program after loading the control program in the RAM.

In the step S301, the CPU 104 makes the image reading unit 101 read an original image by controlling the image reading unit 101, and image data which was read is temporarily stored in the RAM of the storing unit 103. At this time, as the image data to be captured in the RAM, it is captured as the image data of which color components of the pixels of R, G and B respectively have such a gradation corresponds to 256-gradation (8 bit/sample) levels.

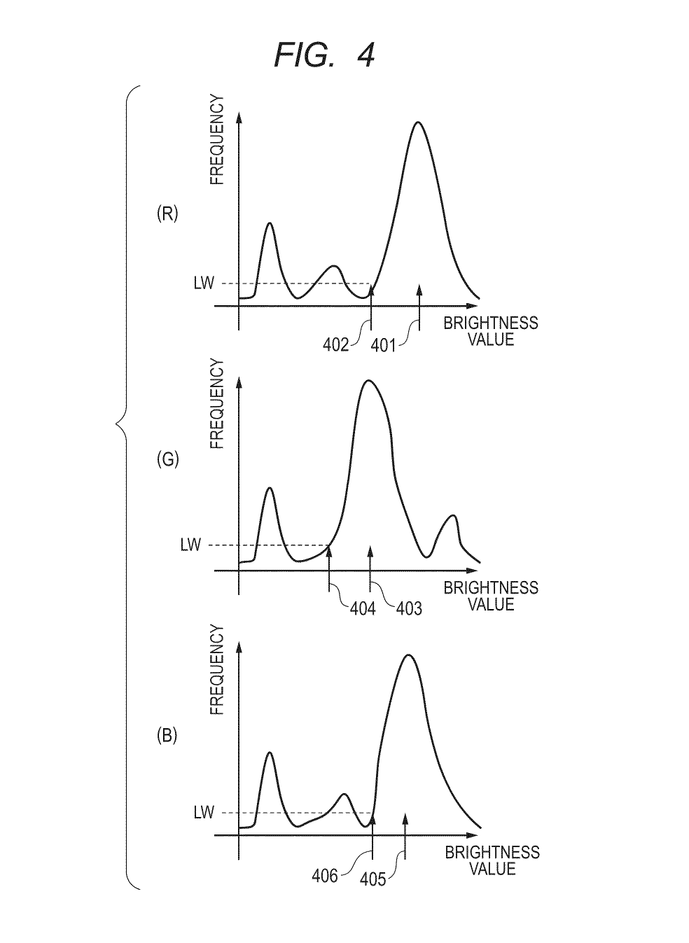

Subsequently, in the step S302, the CPU 104 creates a histogram from the image data of RGB colors captured in the RAM by controlling the image processing unit 102 and creates distributions of respective brightness of R, G and B colors of the image data. Examples of the above RGB distributions will be respectively indicated by graphs (R), (G) and (B) in FIG. 4.

Subsequently, in the step S303, the CPU 104 performs a ground color judging process by controlling the image processing unit 102 and judges the ground color of an original. Specifically, it is considered that a portion 401 fixed by the highest appearance frequency corresponds to a brightness level of the ground color in the histogram of R (red) obtained in a graph (R) in FIG. 4. When considering the extent of skirts of the histogram, by specifying the brightness higher than that of a portion 402 little descending from the portion 401 in the diagram as a ground color level (white level) LW, the ground color can be eliminated without unevenness.

Similarly, the image processing unit 102 specifies a portion 404 of G (Green) as a ground color level LW from a graph (G) in FIG. 4 and specifies a portion 406 of B (Blue) as a ground color level LW from a graph (B) in FIG. 4. In examples of these histograms, since R (red) and B (blue) are brighter than G (green), it can be judged that the color is nearly equal to magenta as the ground color.

In a case that the ground color exists in an original image, it is desirable that an output level of the ground color is reproduced by the same level. That is, by replacing gradations of R, G and B respectively as R=G=B=255 in a ground color region in an image, the ground color of an original is reproduced by white and can be eliminated. The ground color levels of R, G and B indicated by the portion 402 judged as the ground color are respectively defined as Rw, Gw and Bw.

Next, in the step S304, the CPU 104 performs a ground color eliminating process on the basis of the obtained ground color levels Rw, Gw and Bw by controlling the image processing unit 102. This ground color eliminating process is performed by executing calculation to respective values of R, G and B. The above histograms are created for respective colors of R, G and B, and the ground color levels Rw, Gw and Bw are calculated from respective input pixel values R, G and B.

Then, the image processing unit 102 performs calculations indicated in the following numerical expression (1) in accordance with the input pixel values on the basis of the calculated ground color levels, and output pixel values R′, G′ and B′ are calculated from the input pixel values R, G and B. In the numerical expression (1), f_{R}(R,G,B), f_{G}(R,G,B) and f_{B}(R,G,B) become offset values to be determined from the ground color levels and the input pixel values.

R′=R+f_{R}(R,G,B)

G′=G+f_{G}(R,G,B)

B′=B+f_{B}(R,G,B)

f_{R}(R,G,B)={(255−R_{W})/R_{W}×G_{W}B_{W}}×R×G×B

f_{G}(R,G,B)={(255−G_{W})/R_{W}×G_{W}×B_{W}}×R×G×B

f_{B}(R,G,B)={(255−B_{W})/R_{W}×G_{W}×B_{W}}×R×G×B (1)

These offset values become large values in a case that levels of the input pixel values are higher than the ground color levels and become small values in a case that levels of the input pixel values are lower than the ground color levels. In addition, in a case that differences between values of R, G and B are respectively large (high saturation pixels), these offset values similarly become small values, and it becomes possible to keep original color reproducibility. As for the output pixel values R′, G′ and B′ calculated in this manner, the ground color levels are offset for the input pixel values R, G and B, and the values R, G and B are converted into values which are close to the value of R=G=B=255 with respect to color in the vicinity of the ground color level. As for the high saturation color, the original color is stored, and it becomes possible to output the ground color as white while suppressing the color reproducibility deterioration, which is in a region other than that of the ground color, to the minimum.

Next, the CPU 104 performs a density adjusting process to an image, from which the ground color has been eliminated, by controlling the image processing unit 102. Here, the image processing unit 102 may perform such a calculation, where the whole values of R, G and B are decreased to small values in case of intending to increase the density of an image and the whole values of R, G and B are increased to large values in case of intending to brighten the image inversely. In this calculation, by setting that an input operation performed with a 255-gradation level is always output with a 255-gradation level, even if the density has been set to become thick in this density adjusting process, the density of the eliminated ground color is never reproduced to become thick again.

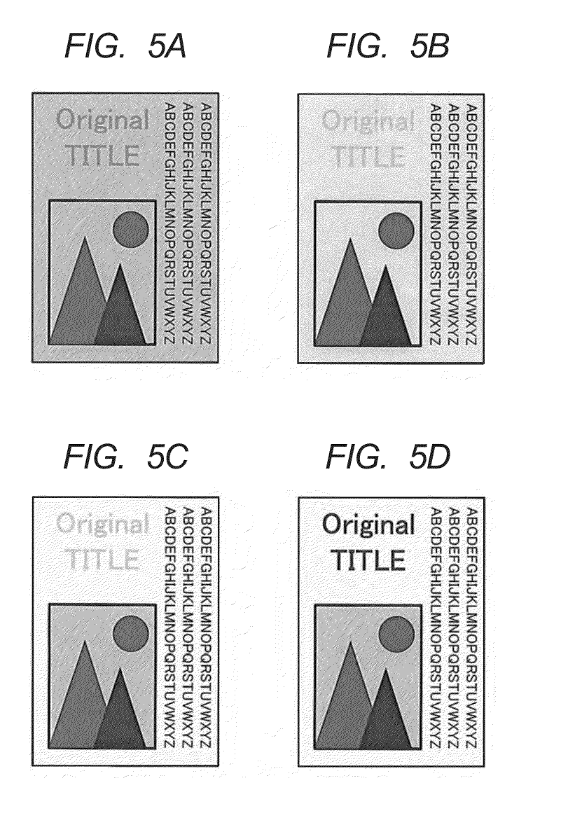

Specific images as a processed result will be described with reference to FIGS. 5A to 5D.

FIG. 5A illustrates an image of an original to be input, and this image has a certain color component on a background, and a background of different color is also imaged in a photographic portion of this image, and the text is written with pale color characters.

FIG. 5B indicates a result that the ground color of a background was judged and automatically eliminated from this image. In this result, not only the color of background is not fully eliminated, but also the background of a photographic portion is about to be thinly eliminated. Like this case, in a case that an original has a complex image, respective histograms of R, G and B colors indicate complex peak and valley forms, and there are many cases that the ground color elimination accuracy is not sufficient by only an automatic judgment.

Therefore, after the color of background was adjusted to become white color by manually performing a ground color adjustment, an adjusting value by which the background of a photographic portion is not eliminated is to be found.

The obtained result becomes a state as in FIG. 5C. Thereafter, a density adjustment is performed in order to increase the density of pale character portions, and then an output as in FIG. 5D is obtained as a final output.

This type of operation is performed while watching an image displayed on the displaying unit 106 in the step S306.

FIG. 6 is a diagram illustrating an example of a user interface of the image processing apparatus indicating the present embodiment. The present example indicates an operation screen used for setting the density adjustment and the ground color elimination to a reading image IM to be displayed on the displaying unit 106 indicated in FIG. 1. In the present embodiment, a case that the operation unit 107 and the displaying unit 106 were integrally constituted by a touch panel form is indicated.

In FIG. 6, the image IM obtained as a result of eliminating the ground color and adjusting the density is displayed on the displaying unit 106, and slider bars 62 which can adjust the eliminating levels which can be calculated from coefficients (ground color levels) R_{W}, G_{W} and B_{W} of a process used for that elimination is displayed on the operation unit 107 at the same time. At the slider bars 62, an eliminating level can be individually adjusted for each of R, G and B.

In the present example, the eliminating levels are indicated by five ranks (0 to 4), which represents that the density of ground color to be eliminated becomes thick in accordance with the increase of numerals of the rank.

That is, it means that when the eliminating level becomes larger, the values of the ground color levels Rw, Gw and Bw become smaller. A density adjusting slider bar 61 is also arranged parallel with the slider bars used for adjusting the eliminating level. In addition, a completion button 63 used for determining a setting value is arranged. That is, when the eliminating level is 0, the ground color level becomes 255, and when the eliminating level advances to 1, 2 . . . , the ground color level becomes smaller, for example, becomes 230, 215 . . . .

An image is displayed on this displaying unit 106 by performing a resolution conversion to the image in accordance with the display resolution so that the whole image is to be displayed.

In a case that an original is formed with a gray color paper such as a newspaper or the like, since the values of R, G and B are mutually approximate values, shapes of the histograms of R, G and B tend to show similar shapes, and values of Rw, Gw and Bw mutually become approximate values. However, in a case that a colored paper such as a red paper, a blue paper or the like is used for the original, shapes of the histograms of R, G and B tend to show such shapes which are large different from each other. According to this fact, the difference between values of the ground color levels Rw, Gw and Bw naturally becomes large.

For example, in a case that the ground color of an original is red, a value of R becomes the largest value in the values of R, G and B, and values of G and B become small values as compared with the value of R. As a result, although a value of the ground color level Rw becomes such a value close to 255, values of the ground color levels Gw and Bw are required to become such values considerably small as compared with the value of the ground color level Rw.

For this reason, if suitable levels are respectively specified to the colors of R, G and B in the ground color judging process, there is no problem. However, for example, when such a value of the ground color level close to 255 is judged also for G (green) in addition to R (red), only the ground color of B (blue) is eliminated. As a result, the ground color of red is not eliminated, and such a color tinged with magenta come to be output.

Therefore, a user adjusts a desired setting value by operating the ground color elimination adjusting bars and the density adjusting bar while visibly confirming the condition of an original, which was read and processed, on the image IM of the displaying unit 106 whether or not the whole image is reproduced to become the desired density. Hereinafter, it will be returned to the description of processes indicated in FIG. 3.

Next, in the step S307, the CPU 104 judges whether or not values of the adjusting bars are changed by the user. When it was judged that an operation of changing the value of the density adjusting bar or the ground color elimination quantity is accepted by the user, the ground color eliminating process and the density adjusting process are performed again by the image processing unit 102 on the basis of the image data stored in the storing unit 103 in accordance with the setting value. Then, that image processed result is displayed on the displaying unit 106. Then, in the step S308, when the CPU 104 judged that the depression of the completion button 63 illustrated in FIG. 6 was accepted, it was judged that the user determined the current setting value as an optimum value, and the process is terminated.

When the completion button 63 was depressed, the CPU 104 judges that a setting value used for reproducing the density finally desired by the user was obtained, then an image is formed and output to a recording medium such as a recording paper by the image outputting unit 105 after the image processing unit 102 performed an image processing by using that setting value.

It becomes possible that the user adjusts the automatically judged ground color level and judges the suitability of that adjusted ground color level by an operation that the user determines a final adjustment value while confirming the condition of an original, which was processed, on the displaying unit 106, and it becomes possible to avoid the occurrence of a defective image due to misjudgment by the automatic processing. Further, it becomes possible to grasp an image that the whole image becomes what level of density after eliminating the ground color by performing the adjustment of density by the user at the same time, and it becomes possible to output an image of which the density is desired by the user, and a copying error can be reduced.

In the present embodiment, a case of calculating the ground color levels from histograms has been described, however, default values are held as functional information of the standard equipment and a process of calculating the ground color levels from histograms can be skipped. In this case, an image scanning process need for creating histograms is not required.

The numerical expression (1) has been exemplified as a ground color eliminating operational expression, however the numerical expression is not limited to this expression but a conversion using a known lookup table or the like is also available. In addition, also regarding the density adjusting process, it may be constituted to have an adjusting process independently performed with the colors of R, G and B or an adjusting process performed with the colors of C, M, Y and K after the color conversion.

As a setting method of the adjusting values, a case that the adjusting values are set by using the 5-step sliders at the operation unit is exemplified at this time, however the number of steps and a setting method are not limited to this case. For example, a method that a user directly inputs values of the above eliminating levels without using the sliders is also available.

### Second Embodiment

In the above first embodiment, although it has been described by exemplifying an output of color image to an input of color image, an output of monochrome image is often performed to the input of color image in a viewpoint of the cost and speed required in the output.

In the present embodiment, it will be described by exemplifying a case that a color image is reformed in a monochrome image and output after performing appropriate ground color eliminating process and density adjusting process to an image which was input by a color mode. Incidentally, as to the constitutions of units illustrated in FIGS. 1 and 2 described in the first embodiment, since these constitutions are similar to constitutions in the present embodiment, the description thereof will be omitted.

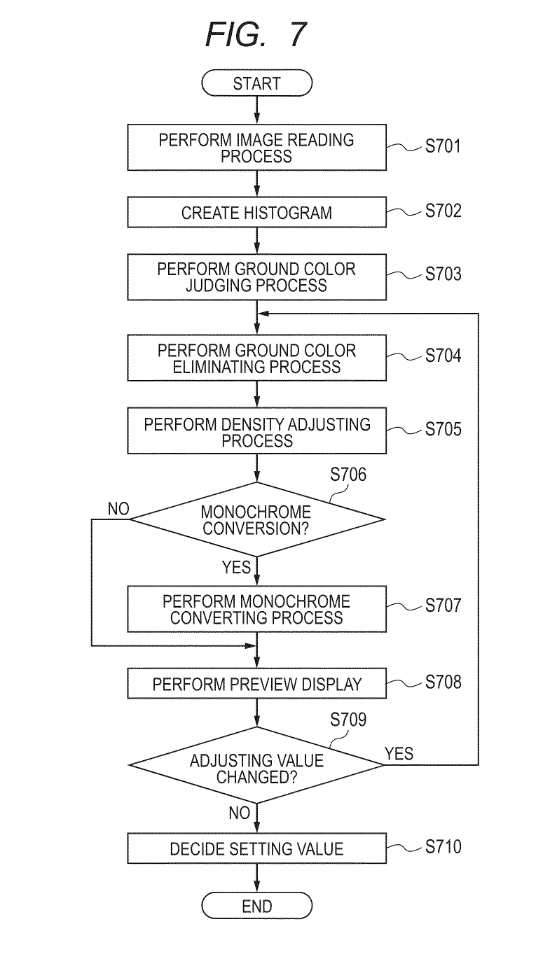

FIG. 7 is a flow chart for describing a controlling method of the image processing apparatus indicating the present embodiment. The present example corresponds to a processing example, wherein when the image reading unit 101 illustrated in FIG. 1 performed to read an original, the eliminating quantity of ground color is automatically discriminated from image data which was read and the ground color is eliminated in accordance with a value of the automatically discriminated eliminating quantity and then the density is adjusted to display the adjusted result. Reference symbols S701 to S710 denote respective steps, and a procedure in each of these steps is realized by a process that the CPU 104 executes a control program after loading the control program in the RAM. A point that is different from the above first embodiment is only such a point that a process of performing a monochrome conversion is added, and as to the same process as that of the first embodiment, the description thereof will be partially omitted.

Several conversion equations related to the conversion from the RGB value to the monochrome value have been proposed. Basically, a weighting calculation is performed to respective color components of R, G and B and then the monochrome value is determined. Specific examples are indicated in (a), (b) and (c) of the following numerical expression (2).

(a) Gray=0.299×R+0.587×G+0.114×B

(b) Gray=0.2126×R+0.7152×G+0.0722×B

(c) Gray=(R+G+B)/3 (2)

In the numerical expression (2), the respective specific weights for colors of R, B and B are different from each other in (a) and (b), and a contribution ratio of B (black) is lower than that of other color components. In (c), an average value of R, G and B is simply calculated as a monochrome value.

Like this, since there are various calculation methods and the weighting to the color components of R, G and B are different from each other, it is hard to judge intuitively that respective colors are converted into what level of density as a result of the calculation. Even different colors are sometimes converted into the same density according to the color. Accordingly, although it was intended to eliminate the ground color, contents information which was basically required also has been eliminated with performance of that intended process, and there sometimes occurs a case that a user cannot obtain a desired output.

Since a flow of processes from an image reading process in the step S701 to a density adjusting process in the step S705 is the same flow as that described in the first embodiment, a description thereof will be omitted.

Next, in the step S706, the CPU 104 accepts an instruction whether or not a result of the monochrome conversion is displayed by operating the operation unit 107 by the user, and it is judged whether or not that instruction indicates to perform the monochrome conversion. Here, when the CPU 104 judged that that instruction indicates not to perform the monochrome conversion, a flow advances to the step S708, and a process similar to that of the first embodiment is performed.

On the other hand, in the step S706, when the CPU 104 judged that that instruction indicates to perform the monochrome conversion, the CPU 104 controls the image processing unit 102 and performs a monochrome converting process to color image data, which was held in the RAM and becomes to serve as original data of an image which was displayed on the displaying unit 106. Then, a flow advances to the step S708, where the CPU 104 previews image data, which was converted into monochrome image data by the image processing unit 102, on the displaying unit 106.

Incidentally, it may be constituted to urge the user to judge whether or not a desired output is obtained by indicating a result of the monochrome conversion to the user at the same time by displaying a monochrome converted result on the displaying unit 106 after eliminating the ground color in the step S704 and performing the density adjustment in the step S705. Further, it may be constituted to control that a display of a color image before performing the monochrome conversion can be also selected in accordance with an instruction from the operation unit 107 or may be constituted that a color component of the ground color to be desired to eliminate can be confirmed on the displaying unit 106.

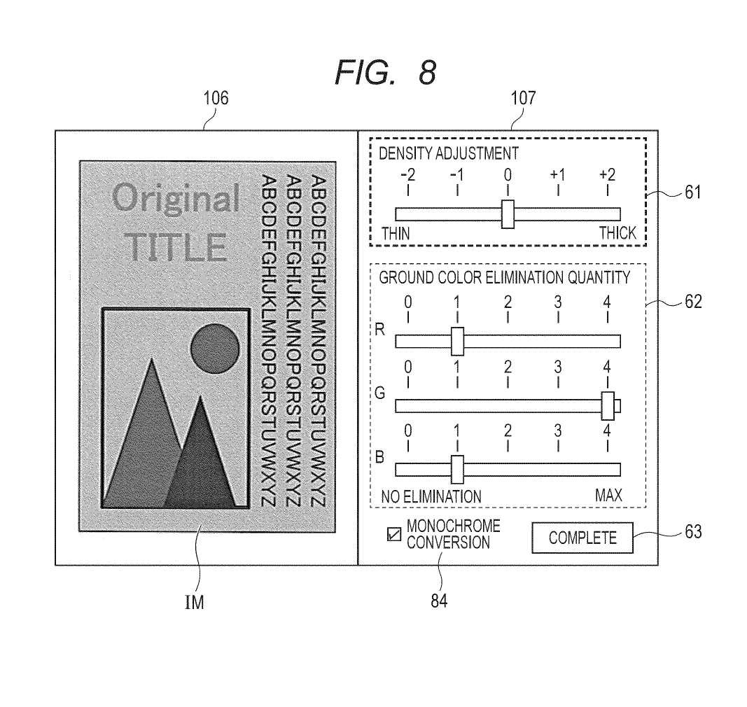

FIG. 8 is a diagram illustrating an example of a user interface of the image processing apparatus indicating the present embodiment. The present example indicates an operation screen used for setting the density adjustment and the ground color elimination to a reading image IM to be displayed on the displaying unit 106 indicated in FIG. 1. In the present embodiment, a case that the operation unit 107 and the displaying unit 106 were integrally constituted by a touch panel form is indicated. The same parts as those in FIG. 6 are denoted by the same reference numerals and the detailed description thereof will be omitted.

In addition, in the present example, a check box 84 used for checking whether or not the displayed color image data is converted into the monochrome image data is further provided to the constitution of a UI (user interface) screen illustrated in FIG. 6. In a case that a final output is the monochrome image data, it is constituted to be able to make a check in the check box.

In a UI screen illustrated in FIG. 8, when the CPU 104 judged that the depression of the completion button 63 performed by the user was accepted, it was judged that a setting value used for reproducing the density desired by the user was finally obtained, and a monochrome converting process is made to be performed by the image processing unit 102. Then, after performing an image processing by using this setting value, the CPU 104 outputs image data expanded on the RAM to the image outputting unit 105, and image data is output to a recording medium such as a recording paper by the image outputting unit 105 as a monochrome image.

In the image outputting unit 105, when the CPU 104 judged that the user previously designated a monochrome output for a printing process performed to a recording sheet, it is allowed to perform a control so as to be different from the above process. Specifically, when the monochrome output has been previously designated, the CPU 104 controls so that the monochrome converted image data is always output to be printed without depending on the setting checked in the check box 84 used for instructing the above monochrome conversion.

Accordingly, it becomes possible to perform the adjustment of the whole density or a setting value of the ground color elimination while confirming that an original color image is to be converted into an image of what level of density by the monochrome conversion, and it becomes possible to obtain an output image of which the density is desired by the user.

### Third Embodiment

In the above first and second embodiments, examples of setting the ground color to be eliminated based on the RGB values obtained from a scanner or the RGB values to which some color converting process was performed, have been indicated.

However, if it is such an original which has simple ground color such as red or blue, it is understood that the ground color can be eliminated by changing an adjusting value of R (red) or an adjusting value of B (blue). But, when complementary color of R, G and B such as yellow or magenta is eliminated, it is hard to understand intuitively that adjusting values of R, G and B should be set by what means.

Therefore, in the present embodiment, such a constitution, wherein it is controlled to display the result on the displaying unit 106 while dispersing the ground color based on the eliminating quantity which was set in another color space, is provided. In the present embodiment, since the constitution of units is similar to the constitution illustrated in FIGS. 1 and 2 described in the first and second embodiments, the description thereof will be omitted.

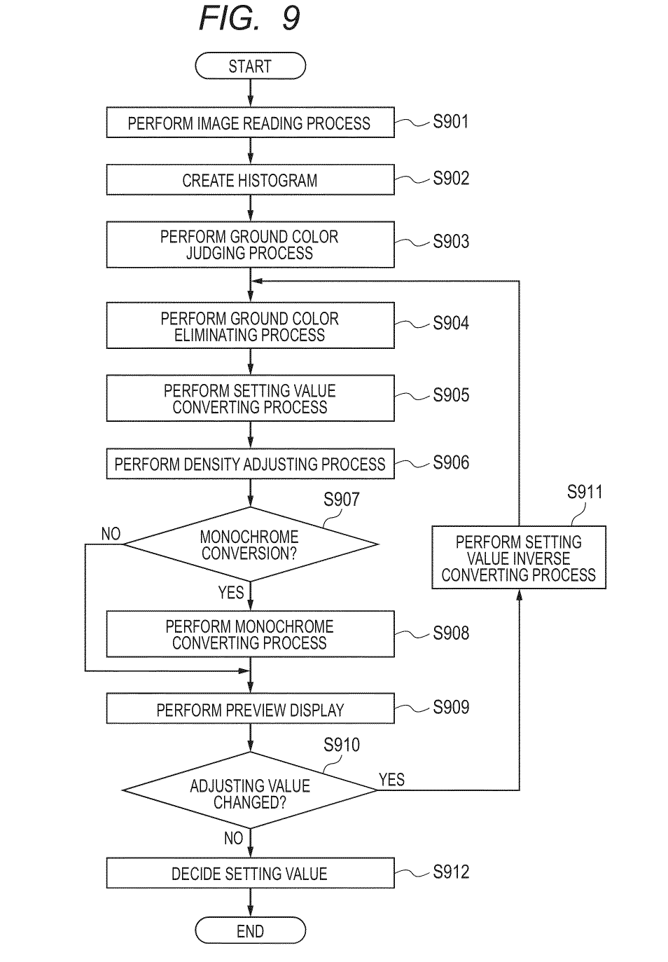

FIG. 9 is a flow chart for describing a controlling method of the image processing apparatus indicating the present embodiment. The present example corresponds to a processing example, wherein when the image reading unit 101 illustrated in FIG. 1 performed to read an original, the eliminating quantity of ground color is automatically discriminated from image data which was read and the ground color is eliminated in accordance with a value of the automatically discriminated eliminating quantity and then the density is adjusted to display the adjusted result. Reference symbols S901 to S912 denote respective steps, and a procedure in each of these steps is realized by a process that the CPU 104 executes a control program after loading the control program in the RAM. A point that is different from the above second embodiment is that a setting value converting process is performed before performing a density adjusting process and a flow does not directly shift to a ground color eliminating process after judging the change of an adjusting value but shifts to the ground color eliminating process after performing a setting value inverse converting process. Hereinafter, as to the same process as that in the second embodiment, the description thereof will be partially omitted.

As described in the second embodiment, the image processing unit 102 performs the ground color eliminating process in the step S904 on the basis of the ground color levels Rw, Gw and Bw judged in the step S903. Thereafter, the image processing unit 102 performs the setting value converting process to the ground color levels Rw, Gw and Bw in the step S905. In this example, the image processing unit 102 uses a setting value in a space, where a person generally can easily perceive colors, as compared with colors of R, G and B. More specifically, a projecting process is performed to spaces of hue, saturation and lightness by converting ground color levels defined by the RGB colors into an HSV (Hue, Saturation, Value) color space.

Hereinafter, conversion equations to be used in a specific converting process will be indicated in the following numerical expression (3).

max=Max(Rw,Gw,Bw)

min=Min(Rw,Gw,Bw)

if (Rw=max)

H=60×(Gw−Bw)/(max−min)+0

if (Gw=max)

H=60×(Bw−Rw)/(max−min)+120

if (Bw=max)

H=60×(Rw−Gw)/(max−min)+240

S=(max−min)/max

V=max (3)

In the above conversion equations, hue (H) is mapped as information of angles from 0° to 360°, and a hue of red is held in the vicinity of 0° and 360°, a hue of green is held in the vicinity of 120° and a hue of blue is held in the vicinity of 240°. In addition, at intermediate angles between the above angles, the hue is mapped into a hue of yellow in the vicinity of 60°, mapped into a hue of cyan in the vicinity of 180° and mapped into a hue of magenta in the vicinity of 300°.

Saturation (S) indicates its vividness by a range from 0.0 to 1.0, and lightness (V) indicates brightness. When the color is gray or the like of which a hue cannot be defined (max=min), the hue (H) becomes indefinite. Similarly, the saturation (S) also becomes 0 (zero). By performing such a setting value converting process, it becomes possible to perform the designation and confirmation of the ground color, which can be intuitively and easily perceived by a person.

As for the subsequent process, it is switched whether or not a monochrome conversion is performed in accordance with the setting set in the operation unit after performing the density adjustment similar to a method described in the second embodiment, and a preview is displayed on the displaying unit.

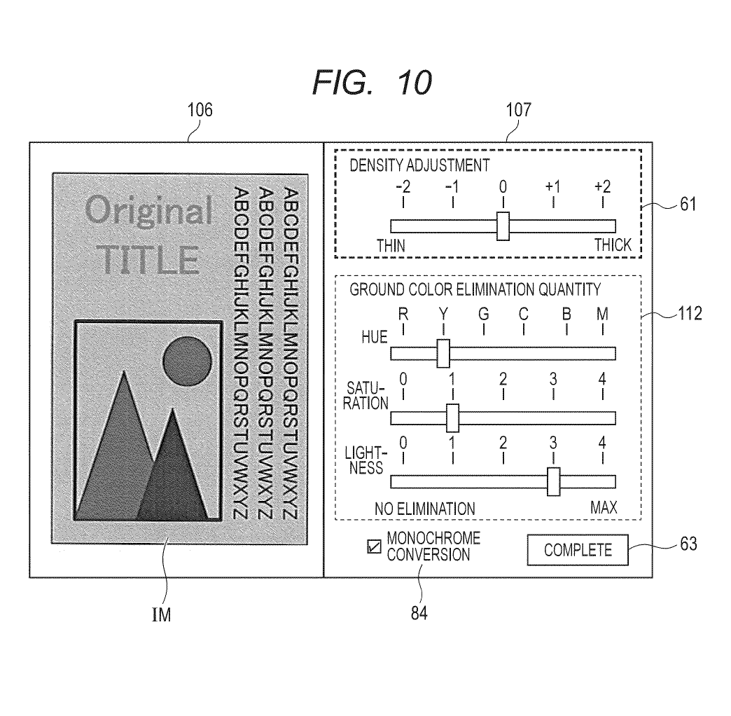

A state of displaying the ground color level of HSV converted in this manner on the operation unit is illustrated in FIG. 10.

FIG. 10 is a diagram illustrating an example of a user interface of the image processing apparatus indicating the present embodiment. The present example indicates an operation screen used for setting the density adjustment and the ground color elimination to a reading image IM to be displayed on the displaying unit 106 indicated in FIG. 1. In the present embodiment, a case that the operation unit 107 and the displaying unit 106 were integrally constituted by a touch panel form is indicated. The same parts as those in FIGS. 6 and 8 are denoted by the same reference numerals and the detailed description thereof will be omitted.

In the present example, the slider bars 62, which can adjust the eliminating level, have been corresponded to the setting of R, G and B in FIG. 6. However, instead of this case, slider bars 112 are displayed to be corresponded to hue, saturation and lightness in the present embodiment. Therefore, colors of Y, M, C and B made to be corresponded to colors of R, G and B every print color are displayed at a hue setting portion.

In this manner, in the present embodiment, as for the elimination levels which can be calculated from the ground color levels Rw, Gw and Bw used for the elimination of the ground color, the slider bars 112 which can adjust the HSV are displayed. Here, the slider bar of hue does not indicate levels, and the hue changes according to a position of the slider bar, and the respective colors are arranged in the order of the hue angle, that is, the colors are arranged in the order of red, yellow, green, cyan, blue and magenta from the left side.

As a ground color eliminating process, since the eliminating process is performed by lightening the ground color, a slider bar of lightness substantially indicates the magnitude of eliminating quantity. In the present example, an example of the setting to eliminate the ground color of yellow which is not so clear color is enumerated. Incidentally, as to an input of gray, the ground color can be eliminated by designating that the saturation becomes a level of zero.

Then, in the step S910, when the CPU 104 judged that a value of the adjusting bar was changed by the slider bar in the operation unit 107, the image processing unit 102 performs an inverse converting process to the setting values of Rw, Gw and Bw again in the step S911 for the setting values expressed by the HSV mode, thereafter a flow returns to the step S904, where the ground color eliminating process is performed in accordance with the inversely converted setting values.

In this way, when the CPU 104 judged that the depression of the completion button 63 was accepted, the setting value used for reproducing the density finally desired by a user is determined. Consequently, after the image processing unit 102 performed an image processing by using the setting value determined by the user, image processed image data is output to the image outputting unit 105. Accordingly, the outputting unit 105 can output image data, from which the ground color was eliminated, to a recording medium such as a recording paper.

According to the present embodiment, it becomes possible to perform the designation of a color, which is to be eliminated, intuitively as compared with a case of performing the setting and adjustment based on the values of R, G and B, and an output desired by a user can be easily obtained.

Incidentally, although it has been described as to the adjustment using the known HSV color space as a color space other than the RGB color space, it is not limited to this case.

### Other Embodiments

Aspects of the present invention can also be realized by a computer of a system or an apparatus (or devices such as a CPU or MPU) that reads out and executes a program recorded on a memory device to perform the functions of the above-described embodiments, and by a method, the steps of which are performed by a computer of a system or an apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-262271, filed Nov. 30, 2011, which is hereby incorporated by reference herein in its entirety.

What is claimed is:

1. An image processing apparatus comprising:
a reading unit configured to generate image data by reading an original;
a displaying unit configured to display a setting section on which it is possible to set an elimination quantity for eliminating a ground color of the original from the image data to each of a plurality of color components and the image data, on an identical screen; and
an image processing unit configured to eliminate the ground color of the original from the image data based on the elimination quantity set on the setting section,
wherein the displaying unit again displays the image data from which the ground color of the original has been eliminated by the image processing unit.

2. The image processing apparatus according to claim 1, wherein
the displaying unit further displays an instructing section on which it is possible to instruct to perform a monochrome converting process of converting the image data into monochrome image data, on the screen on which the setting section and the image data are displayed,
the image processing unit further performs the monochrome converting process in a case where it is instructed on the instructing section to perform the monochrome converting process, and
the displaying unit again displays the image data to which the monochrome converting process was performed.

3. The image processing apparatus according to claim 1, further comprising a printing unit configured to print the image data displayed by the displaying unit, based on an instruction by a user.

4. The image processing apparatus according to claim 1, wherein the plurality of color components include R (red), G (green) and B (blue) components.

5. A controlling method of an image processing apparatus, the method comprising:
generating image data by reading an original;
displaying a setting section on which it is possible to set an elimination quantity for eliminating a ground color of the original from the image data to each of a plurality of color components and the image data, on an identical screen;
eliminating the ground color of the original from the image data based on the elimination quantity set on the setting section; and
displaying again the image data from which the ground color of the original has been eliminated.

6. A non-transitory computer-readable storing medium for storing a program to cause a computer to perform the controlling method of the image processing apparatus according to claim 5.
